(19) United States
(12) Patent Application Publication
(10) Pub. No.: US 2016/0194546 A1
(43) Pub. Date: Jul. 7, 2016

(54) METHODS OF FLUID LOSS CONTROL

(71) Applicants: Michael James Fuller, Cypress, TX (US); Colin Jones, Aberdeenshire (GB); Jonathan Getliff, Aberdeenshire (GB)

(72) Inventors: Michael James Fuller, Cypress, TX (US); Colin Jones, Aberdeenshire (GB); Jonathan Getliff, Aberdeenshire (GB)

(73) Assignee: Chevron U.S.A. Inc., San Ramon, CA (US)

(21) Appl. No.: 14/589,498

(22) Filed: Jan. 5, 2015

(51) Int. Cl. C09K 8/516; E21B 33/138

(52) U.S. Cl. CPC C09K 8/516; E21B 33/138

(57) ABSTRACT

The present disclosure provides a method of reducing localized fluid loss in a wellbore in a subterranean formation by injecting into the wellbore a fluid carrier phase comprising a fluid loss capsule of an active fluid loss control material. The active fluid loss control material is released in the fluid loss zone and reduces localized fluid loss within the wellbore.

### FIELD OF THE INVENTION

The present invention relates generally to strategies for controlling fluid loss in oilfield applications, and more particularly, to a method of selectively reducing fluid loss in a localized loss zone without damaging the permeability of the wellbore.

### BACKGROUND

Fluid loss (FL) into localized zones in subterranean formations has been widely experienced in a variety of wellbore applications, including losses experienced during drilling or cementing; losses during water/chemical-enhanced oil recovery involving injection into induced fractures; and losses of fracturing fluid into either zones of high permeability or into natural fractures. Currently, inert particles are commonly added as a “fluid-loss pill” to minimize losses during these circumstances. Common particles used in such pills include calcium carbonate, bentonite, silica, ground asphalt, ground plastic solids, starch, and others.

However, existing materials have some limitations due to their inert character. First, they experience no bonding to the formation following placement (which could lead to losses following treatment through channeling around packed FL material). Second, due to their inert character, there is no way to cause preferential FL control in the target zone versus anywhere through which these FL control materials are added. Finally, alternative materials (such as rigid resins) can yield a higher resistance to flow (toward FL control) following curing than packed traditional FL-control additives.

FIGS. 1A, 1B, and 1C illustrate the limitations with existing approaches to addressing FL. FIG. 1A shows an example horizontal wellbore 105 with an openhole completion and the desired uniform injection of water/chemical suitable for enhanced oil recovery (EOR) into a permeable formation 107, but there is a zone of weak rock (or fracture) that is beginning to form with accompanying initial localized losses at area 110. FIG. 1B shows the same wellbore 105, but at a later time when the zone of weak rock at area 110 has developed larger fractures causing substantial localized fluid losses. The substantial localized losses in FIG. 1B disturb the desired uniform injection of water or chemical solutions for EOR along the wellbore 105. FIG. 1C illustrates one existing approach to resolving localized losses wherein a conventional fluid loss pill has been introduced into the wellbore 105. However, as shown in FIG. 1C, there is no capability for targeting existing fluid loss pills selectively to fill only the fracture in which the fluid loss is occurring. Instead, the fluid loss pill typically impacts an entire area around the fracture and, while the existing fluid loss pill helps to reduce fluid losses, it has a negative effect on the injectivity into the larger area in the wellbore 105 surrounding the fracture. Accordingly, an improvement to existing fluid loss pills is needed.

### SUMMARY OF THE INVENTION

The disclosure relates to a method for reducing localized fluid loss in a wellbore in a subterranean formation having a loss zone, the method comprising injecting into the wellbore a carrier phase comprising a fluid loss capsule a fluid loss capsule (FL capsule)that is a composite of active fluid loss control material(s) and a coating. In certain embodiments described herein, the fluid loss capsules selectively accumulate within the loss zone before the active fluid loss control material is released from the fluid loss capsules. Upon release, the active fluid loss control material forms a low-permeability fill material (also referred to as a “plug”). Exemplary active fluid loss control materials are selected from the group consisting of swellable materials, partially cured resin materials, resin precursor materials and cement precursor materials. Exemplary coatings are selected from a rigid polymer coating, a wax coating, or a surfactant coating. In certain embodiments, the loss zone is a fracture (that may be pre-existing, e.g., naturally occurring, or induced) wherein the injection step is carried out at an injection pressure that is greater than a fracture propagation pressure to ensure the fluid loss capsule selectively accumulates therein.

### BRIEF DESCRIPTION OF THE FIGURES

Example embodiments of the disclosure may be understood by referring, in part, to the present disclosure and the accompanying drawings, which are briefly described below.

FIGS. 1A, 1B, and 1C illustrate an example wellbore wherein a conventional fluid loss pill is introduced to reduce fluid losses in the wellbore.

FIGS. 2A, 2B-1, 2B-2, and 2C illustrate a wellbore wherein an fluid loss capsules are introduced into a fluid loss zone to reduce localized fluid loss in the wellbore in accordance with an example embodiment of the present disclosure.

### DETAILED DESCRIPTION

Embodiments disclosed herein are generally related to methods and compositions for selectively controlling fluid loss in downhole applications. In particular, embodiments of the disclosed methods comprise the step of injecting into a wellbore a carrier phase comprising a fluid loss capsule that is a composite of i) an active fluid loss control material(s) and ii) an encapsulant.

Particular embodiments of the described methods involve injecting a carrier phase (such as an aqueous or non-aqueous fluid) comprising a fluid loss capsule into a wellbore, wherein the fluid loss capsule accumulates in a loss zone, for example a previously-fractured zone, and wherein the active fluid loss control material is released within the loss zone and acts to reduce fluid communication between the treated loss zone and the wellbore. In particular embodiments, the active fluid loss control material accumulated in the loss zone is selectively released from the fluid loss capsule by one or more of a variety of mechanisms and produces an impermeable or low-permeability fill material (also referred to as a “plug”) within the loss zone. In particular embodiments, the fill material has a strong affinity for the exposed formation-faces within the treated zone.

In preferred embodiments of the method disclosed herein, the carrier phase comprises one or more types of fluid loss capsule injected into a wellbore, the fluid loss capsule being a composite of one or more types of active fluid loss control material and an encapsulant. Encapsulation of active fluid loss control materials protects these materials from reacting, e.g., with the carrier phase, with chemicals dissolved in the carrier phase, with formation solids or fluids, or with adjacent separately-encapsulated chemicals.

In embodiments of the methods described herein, the release of the active fluid loss control material within the loss zone allows the active fluid loss control materials to form a rigid, low-permeability plug that reduces communication between the loss zone and the wellbore. Wellbore candidates for treatment according to the present methods include wells with various completion types, including cased-hole/perforated and openhole completions. Preferably the plug is selectively formed within the loss zone and does not damage the permeability of other portions of reservoir exposed within the wellbore. In some embodiments, the plug forms rapidly upon release of the active fluid loss control material. In alternative embodiments, the material requires time to cure, depending on the conditions in the loss zone. In yet another embodiment, a second injection into the wellbore is required to provide curing agents into the loss zone in order to produce a plug having improved rigidity and reduced-permeability. In some embodiments, this second element may be co-injected together with the first element. In other embodiments, this second element may occur in a subsequent stage following the first stage. Further, in some embodiments both the first and second elements may comprise active materials with encapsulant, and in alternate embodiments only the first element comprises an active material with encapsulant and the second element is not encapsulated.

In certain embodiments of the described methods, suitable candidate subterranean wellbores are those that demonstrate some evidence of a loss zone, including identification of induced fractures formed through characteristic signatures in the injection-pressure during prior injection operations. Candidate wells include the following: injector wells that have experienced fractures or voids induced (opened) through water injection or chemical enhanced oil recovery operations (whereby injection pressure has exceeded the fracture initiation pressure); wells having zones which experience high fluid loss during drilling; and open hole zones in producing wells which have experienced partial collapse (and released formation solids into producing fluids).

Additionally, the size of the capsules (encapsulated active material) can be selected to ensure transport into the loss zone, e.g., induced fracture, rather than bridging at the fracture entrance within the wellbore (leading to residual wellbore damage). The particle size affects the depth to which the particles can penetrate the fracture. In some embodiments, particles can be “bridged out” if the fracture width is less than six-times the size of the diameter of the particles during injection of the FL pill. Particle size can be selected by those of skill in the art. Typical particle sizes are generally between 8 and 325 mesh (44 μm-2.36 mm), for example 16-30 mesh (600 μm 1180 μm), 20-40 mesh (420 μm-840 μm), 30-50 mesh (300 μm-600 μm), 40-70 mesh (212 μm-420 μm), 70-140 mesh (106 μm-212 μm), and smaller sizes. In certain embodiments, the fluid loss capsule will be characterized by a wide range of particle sizes and shapes that will lead to a tight packing arrangement, thereby reducing permeability/conductivity. In alternative embodiments, the fluid loss capsule will be characterized by a narrow range of particle sizes and shapes that will lead to a uniform packing arrangement.

Release of the active fluid loss control material is achieved by a mechanism that depends on the nature of the encapsulant used to form the fluid loss capsule (e.g., rigid, soft, wax), the nature of the active material itself (liquid phase, rigid solid), the nature of the fluid loss void (e.g., fracture, tortuosity, permeation zone, surface roughness), and the downhole conditions including temperature, pressure, formation fluid composition, and drilling fluid composition.

The mechanisms of release exemplified by embodiments of the disclosed methods include: i) physical crushing of the fluid loss capsule, e.g., within a fracture zone, caused by variation of well bore injection pressure; ii) abrasion of the encapsulant caused upon entrance of the fluid loss capsule into a loss zone and abrasive contact against the roughened fracture face; iii) dissolution of at least a portion of the fluid loss capsule coating facilitated by a wellbore injection of a material enhances the dissolution of the encapsulant (either through co-injection or subsequent injection in a second stage); iv) dissolution of the fluid loss capsule coating as facilitated by the downhole conditions (such as temperature) wherein the coating is designed to provide sufficient time for the fluid loss capsule to accumulate in a fluid loss zone before the coating is sufficiently compromised (by dissolution of at least a portion of the coating) and the active fluid loss control material is released.

Successful implementation of the disclosed methods is demonstrated, for example, by: a) poor injectivity into a fracture (or other loss zone) that was treated by the fluid loss capsule(s) described herein (for injector/EOR wells); b) poor production of the formation fluid through the target zone that was treated by the fluid loss capsule(s) described herein; c) minimal residual fluid-loss material left in the wellbore following treatment; or d) flawless execution of the material injection, including avoidance of premature release of fluid loss capsule(s) described herein (that could cause premature loss of wellbore permeability and rapid pressure-increase during injection that itself could initiate formation of new fractures/loss-zones).

Carrier Phase

In certain embodiments the carrier phase comprises fluids of a certain desired viscosity and density. The requirements for viscosity depends on several factors including the composition of the fluid loss capsules (density, size, settling rate, and others) or on the downhole conditions (temperature, pressure, injection rate, formation fluid composition and others). In certain embodiments, the carrier fluid comprises either an aqueous or non-aqueous fluid optionally having a number of additives to render a final set of blended properties. For example, the fluid may be formulated with a certain amount of brine to afford a designed final density (considering the required hydrostatic pressure). The fluid may also comprise certain gelling agents selected from natural polymers (including polysaccharides such as guar, derivatized-guar, HEC, xanthan, derivatized-cellulose, and others), synthetic polymers (such as poly(acrylic acid), polyacrylamide, poly(vinyl alcohol), associated copolymers, and others), crosslinking additives for polymer gelling agents, viscoelastic surfactants, and others. Additional optional additives may include surfactants, bactericide/biocide, demulsifiers, gel-breakers (oxidative breakers or enzyme breakers), solvents, and various other additives that may be designed to impact either the properties of the blended fluid or impact the rate of release of the encapsulated active chemicals.

In certain alternative embodiments, the carrier fluid comprises a nonaqueous fluid with a number of additives designed to render a final set of blended properties. Here, the base fluid may comprise a variety of hydrocarbons including diesel, mineral oil, synthetic oil, and others. These fluids may also include viscosifiers such as organophilic clays, polymers, and components to render aluminum-phosphate ester gels. Additional additives may include weight materials (such as barite, calcium carbonate, and others), emulsifiers, solvents, and a dispersed aqueous phase comprising brine and other aqueous additives.

In additional embodiments, the carrier phase includes materials that improve the integrity and binding of the active fluid loss control materials once released from the fluid loss capsule such as one or more of a suitable catalyst, crosslinking agent and/or a curing agent that react with one or more of the active fluid loss control materials. In alternative embodiments, one or more of a suitable catalyst, crosslinking agent and a curing agent are injected into the wellbore a predetermined period of time after the injection of the fluid loss capsule materials or after the release of the fluid loss capsule comprising plug precursor materials, wherein the “release” is according to one of the release mechanisms described herein.

Active Fluid Loss Control Materials

The active fluid loss control materials contained by the encapsulant of the fluid loss capsule can be essentially any solid or liquid material which does not adversely interact or chemically react with the encapsulant employed to destroy its integrity prior to the desired release of the active FL materials and that is capable of reducing the permeability of the fluid loss zone either upon release or upon interaction with other components such as other fluid loss control materials, materials in the carrier phase, or materials present in the formation.

In certain embodiments, active fluid loss control materials are physically swellable materials, such as those that swell upon exposure to water or other solvents, for example, certain clay solids and polymer materials known to those of skill in the art.

According to embodiments of the disclosed methods, upon release of the contents of the fluid loss capsule, the physically swellable materials are exposed to solvents (e.g., water) from the carrier phase or optionally a subsequent phase and swell to many times their original dry particle size. This effect leads to the effective prevention of further fluid penetration into the fluid loss zone due to the swelling of materials (e.g., polymers), further leading to the sealing of voids within the fluid loss zone thereby preventing fluid movement and preventing communication between the loss zone and the wellbore. In a particular embodiment, the physically swellable materials are swelling of polymers that lead to immediate sealing of voids within the fluid loss zone.

The water swellable clays useful in the composition of the present invention include any colloidal clay mineral which will swell upon hydration with water. Such materials are well known to those in the art. For example, the water swellable clay includes, but is not limited to, a colloidal clay of the dioctahedral or trioctahedral smectite group or mixtures thereof, including bentonite (montmorillonite), beidellite, nontronite, hectorite and saponite. Additionally, the exemplified clay materials also include attapulgite or sepiolite or a mixture of these two clay minerals, or a mixture of these two clay minerals with one or more minerals of the smectite group. Additional examples include polymer treated bentonites known in the art. In a particular embodiment, the colloidal clay mineral is sodium bentonite (sodium montomorillonite) which is finely ground so that approximately 80%, by weight, will pass through a 200 mesh U.S. standard sieve. The fine grind of the colloidal clay aids in its rapid mixing with and hydration within the carrier-fluid in the fluid loss zone.

Also suitable for use as active fluid loss control materials in the disclosed embodiments are modified bentonite clays having a swelling capacity substantially uninhibited in salt water. Examples include the type of bentonite used in water-based drilling fluids such as sodium-montmorillonite-smectite clay.

Other embodiments of active fluid loss control materials include water swellable or superabsorbent polymers. Swellable or superabsorbent polymers known to those in the art can be utilized in accordance with the present invention. For example, hydratable polysaccharides, cross-linked polyacrylates, swellable linear polyurethanes, polyacrylamides, polyacrylamide copolymers and polyvinyl alcohol. Other suitable swellable materials suitable for use in the fluid loss capsule of the present disclosure include: hydratable polysaccharides, galactomannan gums and derivatives thereof, glucomannan gums and derivatives thereof, and cellulose derivatives. Further examples include guar gum, locust beam gum, karaya gum, sodium carboxymethylguar, hydroxyethylguar, sodium carboxymethylhydroxyethylguar, hydroxypropylguar, sodium carboxymethylhydroxymethylcellulose, sodium carboxymethylhydroxyethylcellulose, and hydroxyethylcellulose. In a particular embodiment, hydroxyethylcellulose derivatives used as gelling agents should be those having between 0.5 and about 10 moles of ethylene oxide per anhydroglucose unit.

Other embodiments of active fluid loss control materials include resin or cement precursor materials as known in the art. Specifically, precursor materials require reaction with additional materials, for example with chemicals in the fluid carrier phase, with chemicals dissolved in the carrier phase, with formation solids or fluids, or with adjacent separately-encapsulated chemicals, in order to form rigid resin or cement plugs. In particular embodiments, these plugs are preferably formed within a fluid loss zone.

In specific embodiments, the resin precursor materials include those known to those in the art and include resin monomers for final resins that include epoxy resins, furan resins, acrylic resins, latex (emulsions), polyesters, vinyl esters, polyurethanes, silicones, phenolic resins, urea formaldehyde resins, epoxy resins and others. In certain embodiments, the plug precursor materials also include one or more of a suitable catalyst, crosslinking agent and a curing agent, wherein these additional components are encapsulated separately as necessary to prevent premature reaction prior to release with the encapsulated precursor materials. In alternative embodiments of the disclosed methods, one or more of a catalyst, crosslinking agent and a curing agent are injected into the wellbore, after the release of the fluid loss capsule comprising plug precursor materials.

In specific embodiments, the active fluid loss control materials are not particularly limited and include cement precursor materials known to those in the art for example, materials that produce non-hydraulic or hydraulic cement, in particular, Portland cement blends that set/cure upon exposure to water.

In some embodiments, the fluid loss capsule also includes filler material that comprises inert solids which may include unreactive polymer/plastic solids, sand, alumina, calcium carbonate, and other materials which may act as fill either alone or mixed with above active fluid loss control materials.

Encapsulant Coatings

In embodiments of the method disclosed herein, the active fluid loss control material is encapsulated by an encapsulant until release of the active fluid loss control material is triggered. In certain embodiments, the active fluid loss control material is obtained pre-coated. In alternative embodiments, the active fluid loss control material is formulated and coated on the spot during the operation as a part of the execution of this material or method.

The encapsulant is not particularly limited and is suitably any coating applied by a process known in the art that provides a substantially uniform coating or encapsulation of individual particulate (i.e., between 8 mesh to 325 mesh) whereby the encapsulant coating is sufficiently contains and protects the active fluid loss control material at the time of injection into the wellbore.

In certain embodiments, by varying the encapsulant thickness, the release characteristics can be varied to a large extent, e.g., a shorter release time will be obtained by a thinner coating.

Encapsulation of the active fluid loss control materials is achieved according to methods known in the art. In particular embodiments, the active fluid loss control material may be provided as a solid, liquid, slurry, suspension or emulsion. In an exemplified embodiment, particles of the active fluid loss control material are obtained by any method known in the art, e.g., by granulation of solid materials, and the resulting particles are encapsulated in an encapsulant material according to any method known in the art, for example, by coacervation or fluid bed coating. In an alternative exemplified embodiment, particles of the active fluid loss control material are obtained by spray-cooling a water-in-oil type emulsion, as known in the art. In a particular embodiment, the encapsulated material can include any liquid, preferably aqueous, which does not readily dissolve or disperse capsule coating material. In an alternative embodiment, the active fluid loss control chemicals are provided in a non-aqueous fluid and upon combination and agitation with an emulsifier-additive and the primary aqueous fluid, an emulsification of the active materials will be created for subsequent encapsulation as a FL capsule.

Example embodiments of the formed-encapsulant include crushable capsules formed by thin polymer coatings, for example, those that produce a rigid capsule around the active fluid loss materials. Suitable polymers for forming rigid or crushable coatings are known in the art and are not particularly limited. For example, polycarbonate, polyester, co-polymers of styrene or methyl methacrylate optionally including t-butyl amino ethyl methacrylate.

In additional embodiments, the encapsulant is suitably any coating which is permeable, either due to the permeability of the coating material and/or from flaws, fissures, voids and the like in the coating that form after injection of the FL capsules, to at least one fluid (generally, water) found in the subterranean formation being treated or in the carrier injected with the capsules into the formation and which is capable of releasing the active fluid loss material at the conditions (e.g., temperature) existing in the formation due to an increase in the pressure inside the capsule as compared to the pressure external to the capsule, i.e., the environmental pressure.

In a particular embodiment, the encapsulant is preferably prepared from a material that is permeable to a fluid existing in the subterranean environment, is injected with the capsules into the formation or is injected subsequently to the injection of the FL capsules. The fluid dissolves a portion of the encapsulant to create voids, or the penetration of the fluid into the capsule through the capsule walls creates an increased pressure within the capsule that ruptures the capsule wall. Example coatings formed comprising a dissolvable or degradable substrate are selected from the group consisting of celluloses, derivatized celluloses, starches, derivatized starches, xanthans and derivatized xanthans, homopolymer or copolymer of ethylene, propylene, isobutylene, vinyl chloride, or vinylidene chloride, copolymers of styrene and butadiene, copolymers of vinylidene chloride, esters of an unsaturated carboxylic acid such as methylacrylate, homo or copolymers of epoxide, polycarbonate, ethylene oxide or propylene oxide. Also included are polyester derivatives (such as polylactic acid), poly vinyl alcohols and starch based biopolymers.

Additional embodiments of the encapsulant include paraffin or other wax materials. These materials are not particularly restricted as long as they form the barrier encapsulating the core and are susceptible to one of the mechanisms described herein to release the active fluid loss control materials.

Additional embodiments of the encapsulant include a soft capsule coating formed by a liquid-phase surfactant or liquid-borne polymer materials. In certain embodiments, these materials separate the active fluid loss control material (solution of active fluid loss control material or precursors) from the separate phase of carrier fluid. Examples include any of the numerous amphiphilic compounds known in the coatings art. In a particular embodiment, the trigger mechanism for the soft capsule to release core chemical is upon shearing of the coating, for example, upon passing through a narrow fracture opening.

The properties and conditions influencing the release of the active fluid loss control materials can be tuned with the coating formulation, processing conditions, thickness and layering with different coating materials. The choice of material will depend on a variety of factors such as the physical and chemical properties of the material being employed and the environment into which it is deployed. Coating materials include but are not limited to the following categories: aqueous and organic solutions, dispersions, and hot melts. Non-limiting examples include acrylics, halocarbon, polyvinyl alcohol, Aquacoat® aqueous dispersions, hydrocarbon resins, polyvinyl chloride, Aquateric® enteric coatings, HPC, polyvinylacetate phthalate, HPMC, polyvinylidene chloride, HPMCP, proteins, Kynar®, fluoroplastics, rubber (natural or synthetic), caseinates, maltodextrins, shellac, chlorinated rubber, silicone, Coateric® coatings, microcrystalline wax, starches, coating butters, milk solids, stearines, Daran® latex, molasses, sucrose, dextrins, nylon, surfactants, Opadry® coating systems, Surelease® coating systems, enterics, Paraffin wax, Teflon® fluorocarbons, Eudragits® polymethacrylates, phenolics, waxes, ethoxylated vinyl alcohol, vinyl alcohol copolymer, polylactides, zein, fats, polyamino acids, fatty acids, polyethylene gelatin, polyethylene glycol, glycerides, polyvinyl acetate, vegetable gums and polyvinyl pyrrolidone.

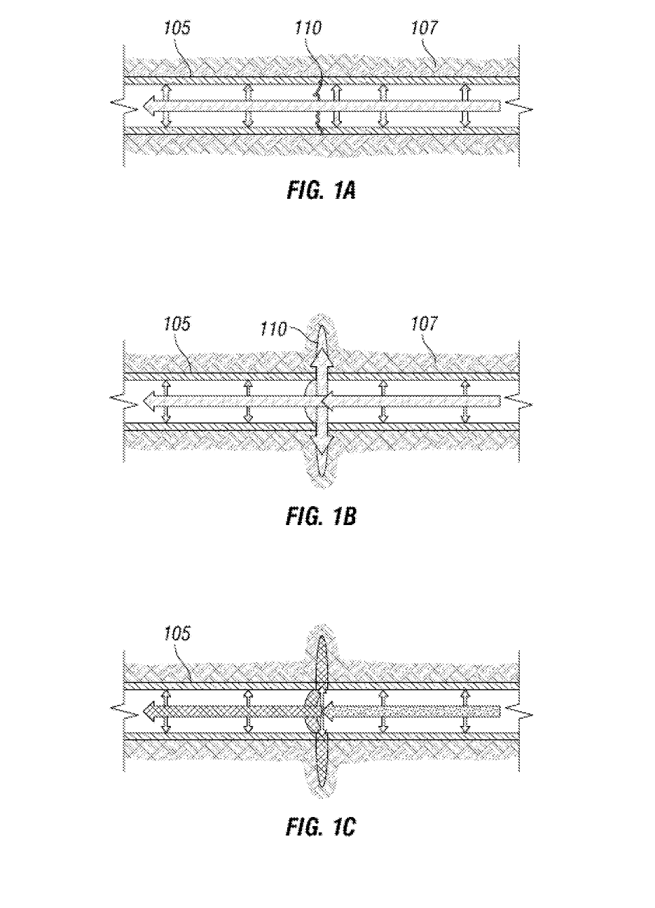

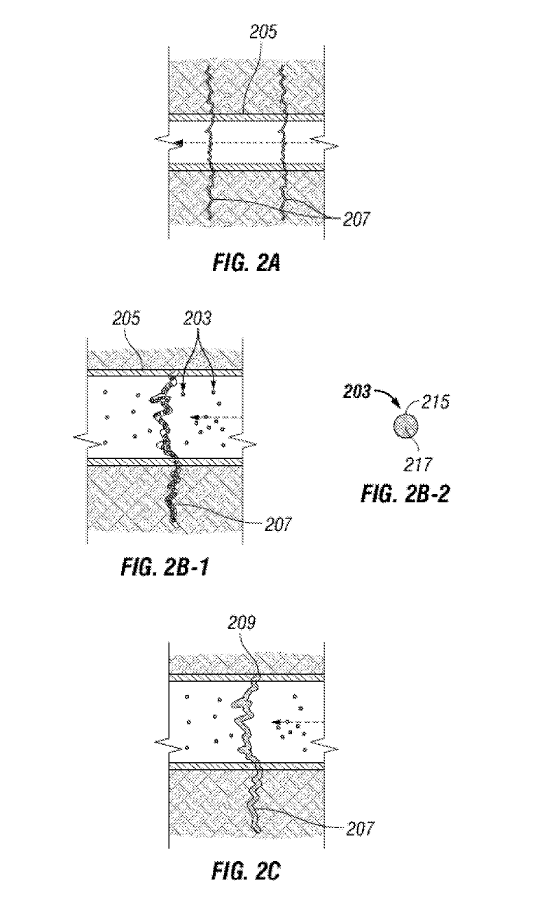

Referring now to FIGS. 2A, 2B-1, 2B-2, and 2C, an example method of reducing localized fluid loss in a wellbore in a subterranean formation by introducing a fluid loss capsule into a wellbore is illustrated. FIG. 2A illustrates an example wellbore 205 that is exhibiting evidence of fractures that are causing localized fluid losses at area 207. FIG. 2B-1 illustrates an injected fluid loss capsule 203 in the wellbore 205 wherein FIG. 2B-2 illustrates the fluid loss capsule 203 as a composite of a protective capsule 215 and active fluid loss materials in the core 217. The fluid loss capsule is targeted for the fracture at area 207. FIG. 3B shows that the active fluid loss control material has been released and provides a targeted plug 209 in the fracture at area 207 thereby reducing fluid loss in the local fluid loss zone 207.

Methods of release of the core active fluid-loss control components from the encapsulated state include a trigger delivered either by direct action or the action of in-situ environmental factors (temperature, pressure, formation fluids) or environmental agents made accessible over time or as a result of an indirect change such as reversal of pressure differentials in the wellbore, mechanical shear (abrasion) or injection of additional agents into the wellbore fluids

In a particular embodiment, the fluid loss zone is a preexisting or previously-induced fracture in the subterranean formation, and the injection of the fluid loss capsule is performed at a pressure greater than the fracture propagation pressure (Pᵢₙⱼ>P_{frac}). The pressure is selected so that the fractured aperture opens to a width sufficient to permit entrance of an amount of the FL capsule. After sufficient time has elapsed to allow the fluid loss capsule to accumulate into the fracture loss zone, a subsequent step of reducing the well bore pressure after injection of the fluid loss capsule is initiated. The reduction in pressure no longer offsets the closure stress and the induced stress causes the fracture to close and initiating a physical crushing of encapsulated core within the target zone, thereby releasing the active fill control material within the facture(s). In particular embodiments, the encapsulating material is thin polymer coating that forms a rigid capsule around the core that is crushed by the fracture closure stress.

In an additional embodiment, the mechanism to release the core materials is abrasion, the physical shearing away of the thin encapsulant or coating when passing through an entrance into the loss zone, such as a fracture aperture. When the injected FL capsules turn from the wellbore into the fracture, the size relative to the fracture width may cause significant shearing away of either hard- or soft-encapsulated materials, thus releasing the active FL control materials.

In an alternative embodiment, the release mechanism is the dissolution of the encapsulant over time upon exposure to downhole conditions such as temperature, pressure, pH, exposure to formation fluids, etc. In an alternative embodiment, after the fluid loss capsule is injected and sufficient time has elapsed to allow the fluid loss capsule to penetrate into a loss zone, the release of the active fluid loss control material is caused by a subsequent injection (or second phase injection) comprising material that dissolves the coating of the fluid loss capsule. The second phase injection may optionally further comprise crosslinking agents, catalysts or accelerators that facilitate the formation of the plug.

Additional embodiments of execution involve injection of the fluid loss capsule at varied pressure, in order to impart selective closure of encapsulant in certain zones based on the fracturing pressure/gradient of those select zones. For example, in the case where a cap-rock above a target zone has a higher fracture pressure (and closure stress) than the target sand zone, one embodiment of the described methods involves injecting the fluid loss capsule at a pressure above the cap rock fracture pressure, which would deliver the fluid loss capsule across the target zone and into the caprock. Following this slug, carrier phase injection rate could be adjusted so that the injection pressure is below the cap rock fracturing pressure, allowing the induced fracture in the cap-rock to close and release the encapsulated FL control material selectively into that zone. Such application could include an optional shut-in stage between these stages to allow any needed curing of FL control material to occur at BH temperature (such as resins).

### EXAMPLES

Examples of fluid loss capsules for improved fluid-loss control may comprise the necessary active fluid loss control materials to make a rigid resin when cured. In certain preferred embodiments, epoxy monomers epichlorohydrin and bisphenol-A are first provided and stored in separate capsules. An additional curing agent may include a diamine material that could be provided either in, for example, a third and separate capsule or unencapsulated in the carrier fluid. In alternative embodiments, the diamine curing agent may be co-encapsulated together with bisphenol-A. In all embodiments, the cores of these individual fluid loss capsules may comprise either an undiluted component or a dilution in suitable medium, such as hydrocarbon or solvent. The diluent will be chosen both to impart a certain core rigidity or viscosity and should also be chosen to avoid premature release from or otherwise weakening of the encapsulant. In particular embodiments, the encapsulant is chosen from suitable rigid materials that would be impermeable to the core material but would yield (e.g., crush) under expected effective-closure stress. In a particular example, the multiple separate encapsulated components, e.g., two or three, would all have roughly the same particle size, to avoid any packing of smaller particles in the voids between larger particles.

In example embodiments of the current invention, a fluid-loss capsule would be injected into a fractured fluid loss-zone in a carrier phase comprising a first fluid loss capsule comprising an epichlorohydrin solution, a second fluid loss capsule comprising bisphenol-A solution, and a third fluid loss capsule comprising diamine curing agent solution. This injection would be carried out at a rate sufficient to provide downhole pressure in excess of the fracture propagation pressure. The injection of the carrier phase is followed by the injection of a fluid that does not include a fluid-loss capsule. The injection of the fluid-loss capsules would be displaced by this fluid and the encapsulated FL material would thereby be displaced from the wellbore into the fracture. Following this injection sequence that includes displacement, the injection would be halted and the wellbore pressure allowed to reduce, allowing the internal fluid pressure in the fracture to release and the closure pressure to crush the encapsulated materials. In certain embodiments, following closure the wellbore may be aged without any subsequent injection for a period of time, for example, number of hours. During this ageing, the released components would mix within the fracture. In certain embodiments, the bottomhole temperature increases during this aging period facilitating the mixed components to react, thereby yielding an impermeable resin plug.

As would be understood by a person of ordinary skill in the art, the practice of injecting the capsules is such that the volume of the encapsulated FL material doesn't fill up the entire wellbore and is a lesser volume; but to make sure there is minimal encapsulated FL material remaining in the wellbore after injection into the localized fluid loss zone, the injection sequence may require the injection of some fluid with the right properties to displace (a significant portion or most of) the pill into the preferred zone (loss zone). This fluid could most preferably be viscosified (as a nonviscous fluid might ‘finger through” the encapsulated FL material leading to poor displacement efficiency) or a weighted/brine fluid (to utilize added hydrostatic to displace the capsules). In an alternative embodiment, a high-rate water/chemical-EOR injection fluid may be used to displace the encapsulated FL material from the wellbore, despite the lower displacement-efficiency of this practice.

1. A method for reducing fluid loss in a localized loss zone in a wellbore in a subterranean formation having a fracture, the method comprising the steps of:
A) injecting a carrier phase into a wellbore, the carrier phase comprising one or more types of a fluid loss capsule, each fluid loss capsule comprising an active fluid loss control material and an encapsulant,
B) releasing the active fluid loss control material from the fluid loss capsule within the fracture by crushing the encapsulant by a fracture closure stress thereby
forming, with the active fluid loss control material, a rigid low-permeability plug in the fracture that reduces communication between the localized loss zone and the wellbore.

2. The method of claim 1, wherein the one or more types of a fluid loss capsule includes a first fluid loss capsule comprising one or more active fluid loss control materials selected from the group consisting of swellable materials, partially cured resin materials, resin precursor materials, swellable clays, and cement precursor materials.

3. The method of claim 2, wherein the one or more types of a fluid loss capsule includes a second fluid loss capsule, the second fluid loss capsule comprising one or more active fluid loss control materials selected from the group consisting of catalyst materials, activator materials, crosslinking materials, curing agents, and hardening agents.

4. The method of claim 1, wherein the encapsulant is selected from the group consisting of a polymer coating, a wax coating and a surfactant coating.

5. The method of claim 1, wherein the injecting step is carried out at an injection pressure that is greater than a fracture propagation pressure of the fracture.

6. The method of claim 5, wherein the injecting step is followed by a step of reducing the injection pressure below the fracture propagation pressure thereby allowing application of fracture closure stress to release the active fluid loss control material within the fracture.

7. (canceled)

8. The method of claim 6, wherein the encapsulant is a polymer coating.

9. The method of claim 6, wherein the size of the fluid loss capsule ranges from 8 to 325 mesh.

10.-12. (canceled)

13. The method of claim 1, wherein the fluid loss capsule is a particle having a size distribution ranging from 8 mesh to 325 mesh.

14. A method for reducing localized fluid loss in a wellbore in a subterranean formation having an existing or previously induced-fracture zone, the method comprising:
A) injecting a carrier phase into a wellbore at an injection pressure that exceeds a fracture propagation pressure, the carrier phase comprising one or more types of a fluid loss capsule, each fluid loss capsule comprising an active fluid loss control material and an encapsulant, wherein the active fluid loss control material is selected from the group consisting of partially cured resin materials, resin precursor materials, cement precursor materials, catalyst materials, activator materials, crosslinking materials, hardening agents and mixtures thereof;
B) injecting a fluid that does not comprise the fluid loss capsule into the wellbore thereby forcing the fluid loss capsule into the existing or previously induced-fracture zone;
C) allowing time sufficient for the fluid loss capsule to accumulate in the existing or previously induced-fracture zone;
D) reducing the injection pressure to less than the fracture propagation pressure thereby increasing fracture closure stress within the existing or previously induced fracture zone wherein the increased fracture closure stress acting on the encapsulant causes release of the active fluid loss control material
thereby forming a rigid low-permeability plug ; with the released active fluid loss control material within the existing or previously induced-fracture zone that reduces communication between the existing or previously induced-fracture zone and the wellbore.

15. (canceled)

16. (canceled)

17. The method of claim 14, wherein the encapsulant is selected from a polymer coating, a wax coating, or a surfactant coating.

18. The method of claim 14, wherein the encapsulant is a polymer coating.

19. (canceled)

20. The method of claim 14, wherein the fluid loss capsule is a particle having a size distribution ranging from 8 mesh to 325 mesh.

21. The method of claim 1, wherein the active fluid loss control material is a precursor material selected from partially cured resins, resin precursors and cement precursors, and wherein the carrier phase further comprises one or more selected from catalyst materials, activator materials, crosslinking materials, curing agents and hardening agents, and wherein upon release of the precursor material, the precursor material reacts with the carrier phase to form the rigid, low-permeability plug.

22. The method of claim 21, wherein the catalyst materials, activator materials, crosslinking materials, curing agents and hardening agents are in the form of one or more of a fluid loss capsule.

23. (canceled)

24. The method of claim 21, wherein the precursor material comprises epoxy monomers and wherein the carrier phase further comprises a diamine curing agent.

25. The method of claim 24, wherein the epoxy monomers are selected from epichlorohydrin, bisphenol-A and mixtures thereof.

26. The method of claim 1, wherein the one or more types of a fluid loss capsule includes a first fluid loss capsule comprising epichlorohydrin, a second fluid loss capsule comprising bisphenol-A and a third fluid loss capsule comprising a diamine curing agent.

27. A method for reducing fluid loss in a wellbore in a subterranean formation having a localized loss zone, the method comprising:
A) injecting a carrier phase into a wellbore, the carrier phase comprising one or more types of a fluid loss capsule, wherein each fluid loss capsule comprises a dissolvable encapsulant and an encapsulated active fluid loss control material selected from the group consisting of partially cured resin materials, resin precursor materials, cement precursor materials, catalyst materials, activator materials, crosslinking materials, hardening agents and mixtures thereof;
B) allowing time sufficient for the fluid loss capsule to accumulate in the loss zone;
C) injecting a second carrier phase comprising one or more agents that trigger the dissolution of the dissolvable encapsulant and causes release of the encapsulated active fluid loss control material, thereby forming a rigid low-permeability plug with the released active fluid loss control material within the loss zone that reduces communication between the loss zone and the wellbore.
